(19) United States
(12) Patent Application Publication
(10) Pub. No.: US 2007/0040925 A1
(43) Pub. Date: Feb. 22, 2007

(54) Devices and method for imaging continuous tilt micromirror arrays

(76) Inventor: R. Andrew Hicks, Philadelphia, PA (US)

Correspondence Address: LICATA & TYRRELL P.C., 66 E. MAIN STREET, MARLTON, NJ, 08053, US

(21) Appl. No.: 10/576,990

(22) PCT Filed: Nov. 1, 2004
(86) PCT No.: PCT/US04/36430

§ 371 Date: Apr. 26, 2006

Related U.S. Application Data
(60) Provisional application No. 60/516,360, filed on Oct. 31, 2003.

(51) Int. Cl. H04N 5/225

(52) U.S. Cl. 348/340

(57) ABSTRACT

Devices for producing high resolution photographic images of a scene from assembled or mosaiced color values extracted from pixels of the scene reflected by a micromirror array to a photographic imaging system are provided.

### INTRODUCTION

This patent application claims the benefit of priority from U.S. provisional patent application Ser. No. 60/516,360, filed Oct. 31, 2003, which is herein incorporated by reference in its entirety.

This invention was supported in part by funds from the U.S. government (NSF Grant No. DMS-0211283). The U.S. government may therefore have certain rights in the invention.

### FIELD OF THE INVENTION

The present invention relates to devices and methods of use of devices comprising a photographic imaging system, a micromirror array and a pixel assembly system or algorithm. The devices of the present invention provide for real time, high resolution image acquisition by mosaicing of pixels of a scene reflected by micromirrors of the micromirror array when mirrors are tilted individually in at least two different directions. The pixels are collected by the photographic imaging system and reassembled by the pixel assembly system or algorithm into a high resolution image of the scene.

### BACKGROUND OF THE INVENTION

For decades, the lens-CCD chip paradigm has dominated visual sensor design. An important design goal of visual sensors is to enhance or increase their resolution.

To create a very high resolution image, typically several images are taken and then pasted together. This method, known as mosaicing can yield impressive results. However, with conventional devices the images are obtained slowly, since the camera must be moved many times. Further, the introduction of mechanical devices into imaging systems has largely been avoided, because moving a macroscopic camera at the required speeds is difficult and is potentially damaging to the camera.

A system for creating spherical mosaics using a zoom lens and a pan-tilt mechanism mounted on a robot was described by Kropp et al. (Proceeding IEEE Workshop on OmniDirectional Vision 2000 47-53). However, the acquisition process is slow since the camera position must be moved many times to capture a complete image.

Another approach has been to fix the camera's position and place a mirror in front of the camera, which can then be moved to create a mosaic with increased field of view (Nakao, T. and Kashitani, A. International Conference on Image Processing, Oct 7-10, 2001, 2:1045-1048). However, manual movement of the mirror also has disadvantages and is still slow.

During the past twenty years, the field of micro-electro-mechanical systems (MEMS) has developed remarkable capabilities and the possible applications are only beginning to be grasped.

One micro-optical-electro-mechanical system (MOEMS) is the digital micromirror device or DMD. The DMD was developed at Texas Instruments over a period of years, starting in the 1970s. This device consists of a chip covered with an array of small mirrors, each of whose orientation may be separately controlled. The typical size of an individual micromirror is approximately 15 μm square and is made of a highly reflective aluminum alloy. One of the main advantages of being small for an optical device is the ability to change state rapidly. In the case of a DMD, this can be in the megahertz range.

The primary use of MOEMS has been in projectors. In projection, one or more micromirrors corresponds to a single pixel in a projected image. Different light is reflected by the micromirrors and the relative amount of time each mirror is in the “on” or “off” position when red, blue or green light shines on it determines the hue of and shade of the pixel it generates. A projector incorporating micromirrors operates by reflecting light rays from an external source into the pupil of an imaging lens. The imaging lens then projects the digitized image onto the screen.

Micromirror arrays are also used in microscopy, retinal scanning and lithography.

In these applications, the micromirror array generally acts as a mask, and the individual mirror elements have only two states (Hornbeck, L. Texas Instruments Technical Journal 1998 15:7-46).

Micromirror arrays are also used in optical switching (Wu, M. C. Proceedings of the IEEE 1997 85(11):1833-1856). Optical switching is an application where continuous pitch micromirror arrays have been used. For example, U.S. Pat. No. 6,600,651 discloses an optical switch comprising mirror elements each of which can be assigned an arbitrary orientation, i.e. each mirror has a full 2 degrees of freedom with respect to tilt. A fiber optic communication system utilizing MEMS tilting mirrors is also disclosed in U.S. Pat. No. 6,690,885.

U.S. Pat. No. 6,700,606 discloses an optical imager with a light source, a platen for reflecting a portion of light emitted by the light source, an image sensor for sensing the light and a micromirror device with a first position which reflects light reflected from a first location on the platen and a second position which reflects light reflected from a second location on the platen to the image sensor. This optical imager is suggested to be useful in imaging a fingerprint placed against the platen.

Nayar et al. describe a programmable imaging system comprising a digital binary micromirror array, which provides an image by taking a single picture of the array (XCVPR 2004 1:436-443). In this system the micromirror array acts as a mask.

### SUMMARY OF THE INVENTION

An object of the present invention is to provide a device for forming high resolution images which comprises a photographic imaging system and a micromirror array containing an array of micromirrors, each mirror being capable of tilting in at least two directions. The micromirror array is positioned with respect to the photographic imaging system so that each mirror of the micromirror array transfers a reflected pixel of the scene to be photographed to the photographic imaging system. The device further comprises an assembly system or algorithm which forms a high resolution image of the scene by mosaicing relevant color values extracted from each reflected pixel from each mirror of the micromirror array into a high resolution image of the scene.

Another object of the present invention is to provide a method for producing a high resolution image of a scene via a photographic imaging system by incorporating into the photographic imaging system a micromirror array positioned with respect to the photographic imaging system to be capable of transferring reflected pixels of the scene to the photographic imaging systems. In the method of the present invention, a high resolution image of the scene is reassembled algorithmically by mosaicing relevant color values extracted from the reflected pixels from the mirrors of the micromirror array when each mirror is tilted individually in at least two different directions.

### BRIEF DESCRIPTION OF THE FIGURES

FIGS. 1A and 1B show schematic diagrams of the basic concept of image acquisition used in the device of the present invention. FIG. 1A provides a diagram wherein the mirrors of the micromirror array are tilted to reflect pixels of points 1, 3, 5, 7 and 9 of the scene to the photographic imaging system, in this example a camera. In FIG. 1B, the state of the mirrors has been changed to transfer a reflection of the pixels at points 2, 4, 6, 8 and 10 of the scene.

FIGS. 2A and 2B show results from a simulation experiment of a photograph of a desktop. FIG. 2A is a photograph of an overhead view of a desktop scene taken with a simulated pinhole camera. FIG. 2B is a 640 by 448 image of the same scene created by mosaicing color values corresponding to pixels reflected from a simulated micromirror array in accordance with the present invention. To produce this image of FIG. 2B, 70 images of a 64×64 mirror array in different configurations were generated, subsampled and joined or mosaiced together.

### DETAILED DESCRIPTION OF THE INVENTION

In the present invention, an optical MEM or MOEM system comprising a micromirror array consisting of a plurality of microscopic mirrors capable of tilting individually at least two different directions and changing state thousands to millions of times per second, is incorporated into a photographic imaging system with an assembly system or mosaicing assembly algorithm to provide devices and methods for use of such devices to produce high resolution photographic images.

In the devices of the present invention, a micromirror array is positioned with respect to a photographic imaging system so that each mirror of the micromirror array transfers a reflected pixel of the scene to be photographed to the photographic imaging system. The device further comprises an assembly system or algorithm which forms a high resolution image of the scene by mosaicing each reflected pixel as a color value from each mirror of the micromirror array into a high resolution image of the scene. In one embodiment, the photographic imaging system is linked to a separate computer with the assembly algorithm.

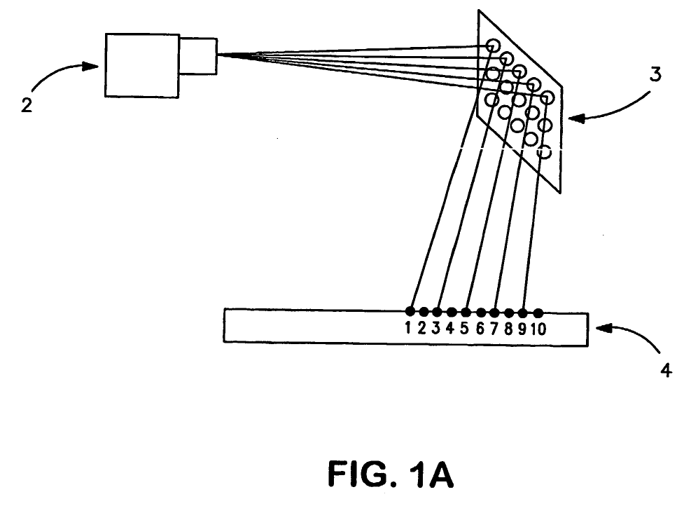

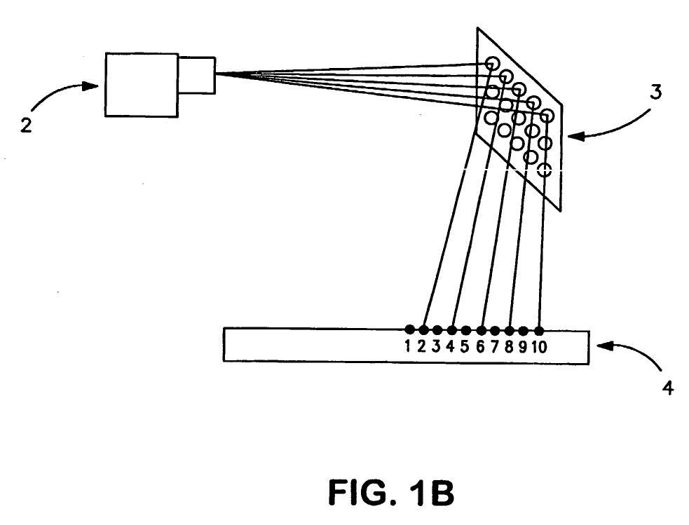

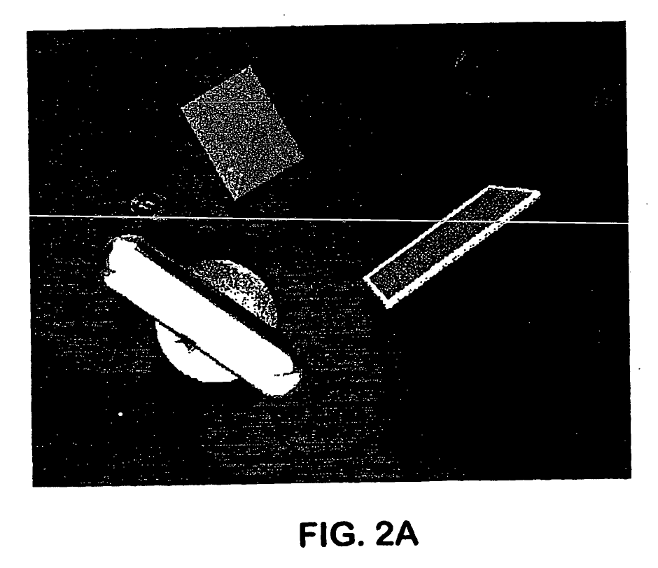

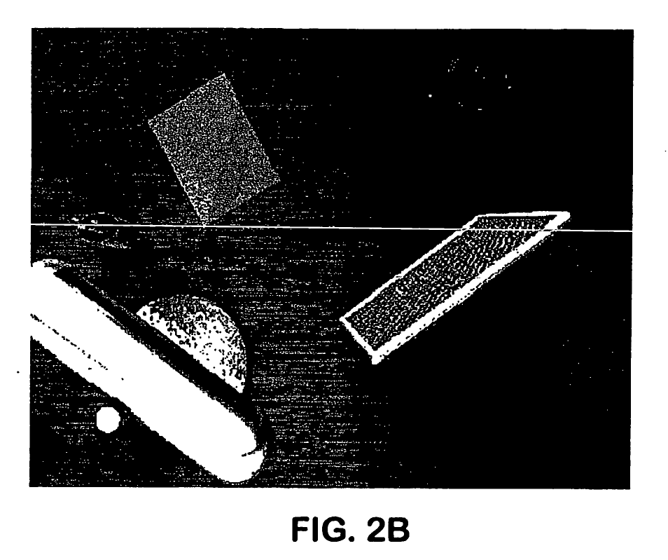

One configuration for the photographic imaging system and micromirror array of the device of the present invention is depicted in FIGS. 1A and 1B. As shown therein, a photographic imaging system 2 such as a video camera or other camera capable of collecting digital images is pointed at a micromirror array 3. The micromirror array 3 is positioned with respect to the photographic imaging system 2 and the scene 4 to be imaged so that a reflection of the scene 4 is transferred to the photographic imaging system 2. Thus, the micromirror array acts in similar fashion to a conventional mirror with the exception that it can reconfigure the state of the mirrors very rapidly. Preferably, each mirror of the array is individually controllable, and has at least 2 tilt directions so that instead of moving the photographic imaging system to obtain multiple images of a scene, the mirrors of the array move to produce different reflections of the same scene. In order to form a high resolution image of the scene using this device, one photographs the array with the mirrors in many different states. The final resulting image of the scene is assembled via an assembly system or algorithm from reflected pixels and corresponding color values extracted from the reflected pixels from each mirror. Thus, for each high resolution image or photograph the individual mirrors are imaged, and each is individually oriented so that from the photographic imaging system's point of view it reflects a small portion of the scene. From each reflected pixel from each mirror one or more color values may be extracted. These correspond to points in the scene. Since the position of the micromirror array and relative position of the photographic imaging system are known, it is possible to then place or assemble the color values into a matrix that forms a final photograph of the scene. In other words, the positions of the pixel in the final image are determined by the basic known geometric quantities of the device and the elements thereof. The greater the number of states of the mirrors, the larger the number of color values extracted, and so the higher the resolution of the resulting image. In this device, the individual images are recorded at frame rate, i.e. the rate at which images are viewed on television (or even faster). All of the images for the resulting photograph of the scene can thus be obtained very rapidly, and then assembled into a single highly resolved image via an assembly system or algorithm. Such algorithms are well known to those skilled in the art and can be programmed in multiple computer languages including, but in no way limited to Matlab TM or C. The algorithms are based upon the geometry of the device of the present invention and the elements thereof.

Examples of photographic imaging systems into which the MOEM or MEM system can be incorporated include but are not limited to digital cameras and video cameras.

An exemplary MOEM system useful in the present invention is the Lucent LambdaRouter array. This MOEM system is described in detail in U.S. Pat. No. 6,690,885, the teachings of which are herein incorporated by reference in their entirety. The Lucent LambdaRouter array is a 16×16 array with each mirror having a tilt angle of ±8 degrees. It has been estimated that each of the two angles of this array is controllable to within 0.05 degrees thus providing for 320 states in each angle (Gasparyan et al. In post deadline paper PD36-1, OFC, 2003). However, as will be understood by those skilled in the art upon reading this disclosure, any micromirror array with mirrors which can be tilted individually in at least two directions can be used.

Micromirror arrays for use in imaging systems in accordance with the present invention are preferably constructed on surfaces using silicon substrates in accordance with established technologies for MEMS and MOEMS.

Assembly systems or algorithms capable of mosaicing the reflected pixels of each mirror of the micromirror arrays into a single image are well known to those skilled in the art. These algorithms are based upon the geometry of the device of the present invention and the elements thereof. Such algorithms can be programmed in multiple computer languages including, but in no way limited to Matlab TM or C.

The resolution of an image acquired using the device of the present invention is only limited by the number of mirrors that are observable times the number of distinct states achievable by an individual mirror. Thus, the resolution achievable for a device of the present invention comprising, for example, a Lucent LambdaRouter array (with an estimated 320 states in each angle and a total number of distinct states in an individual being on the order of 100,000) is on the order of 25 megapixels.

Thus the devices of the present invention provide a means for greatly increasing the current resolution of photographic imaging systems such as digital cameras and video cameras. These devices can also greatly enhance the resolution of omnidirectional surveillance cameras which often suffer from low resolution.

The following nonlimiting example is provided to further illustrate the present invention.

### EXAMPLE

The ability of a device of the present invention to increase image resolution was demonstrated using a geometric raytracing simulation.

In this simulation, a 64×64 micromirror array having 2 degrees of freedom was assumed. Each individual mirror was assumed to be configurable in any orientation so that the simulated device could exactly realize the distributions needed to perform mosaicing. Seventy ray tracing simulations were performed with this array to create a 640×448 image of a desktop scene. The resolution of each of the 70 images was 640×480 and had to be subsampled to remove the rgb values from each of the mirrors.

To create each of the 70 images, the simulated array was placed above the table and tilted down at 45 degrees. The 70 different distributions were calculated, each one corresponding to a small tile in the image. Using this information, the orientation of the mirrors was calculated and an image generated by the raytracer.

To obtain higher resolution images, more than one sample rgb value could be extracted from each micromirror, an array with more micromirrors could be used, or more images could be acquired.

What is claimed is:

1. A device for producing a high resolution photographic image of a scene, said device comprising:
(a) a photographic imaging system;
(b) a micromirror array containing an array of micromirrors, each mirror being capable of tilting individually in at least two directions, said micromirror array being positioned with respect to the photographic imaging system so that each mirror of the micromirror array transfers a reflected pixel of the scene to be photographed to the photographic imaging system; and
(c) an assembly system which forms a high resolution image of the scene by mosaicing extracted color values from each reflected pixel from each mirror of the micromirror array into a high resolution image of the scene.

2. The device of claim 1 wherein the photographic imaging system comprises a digital camera or a video camera.

3. A method for producing a high resolution image of a scene comprising:
(a) photographing reflected pixels from the micromirror array with the photographic imaging system of the device of claim 1;
(b) extracting relevant color values from each reflected pixel; and
(c) assembling the extracted relevant color values into a high resolution image of the scene.
